(19) United States
(12) Patent Application Publication
(10) Pub. No.: US 2014/0058980 A1
(43) Pub. Date: Feb. 27, 2014

(54) METHOD FOR FACILITATING BUSINESS NETWORKING

(71) Applicant: Avant Garde Events, Inc., Milton, MA (US)

(72) Inventor: Valerie A. McSorley, Milton, MA (US)

(73) Assignee: Avant Garde Events, Inc., Milton, MA (US)

(21) Appl. No.: 13/971,197

(22) Filed: Aug. 20, 2013

Related U.S. Application Data
(60) Provisional application No. 61/691,927, filed on Aug. 22, 2012.

(51) Int. Cl. G06Q 90/00

(52) U.S. Cl. CPC G06Q 90/00
USPC 705/500

(57) ABSTRACT

Embodiments of a method for efficiently and effectively facilitating introductions between individuals who can help each other professionally include promoting an event in a locally focused medium that appeals to business leaders, requiring advance registration, charging a fee, and limiting attendance. A list of expected attendees can be available for review upon arrival, and introductions can be made at the beginning of the event while cocktails are served. A guest speaker can makes a presentation of general interest, after which each attendee is required to briefly tell the group who they are, and what they are specifically seeking. Each attendee must also make a special offer that is only valid until the next event. Time is then provided for attendees to approach each other individually. In embodiments, attendees must provide to the host summaries of their presentations, which are circulated to all attendees after the event.

### RELATED APPLICATIONS

This application claims the benefit of U.S. Provisional Application No. 61/691,927, filed Aug. 22, 2012, which is herein incorporated by reference in its entirety for all purposes.

### FIELD OF THE INVENTION

The invention relates to methods for facilitating introductions between individuals, and more particularly, to events that bring together individuals who potentially can be of help to each other and facilitating introductions there between.

### BACKGROUND OF THE INVENTION

It has been said that in many fields of activity, including business, politics, theater, and others, it is not what you know, but who you know, that is important. It has also been said that people don't buy from companies, people buy from people. While these may be overstatements, it is certainly true that relationships between individuals can be highly valuable to the success of any business or other enterprise. The process of forming these professional relationships is often referred to as “networking,” and the sum of an individual's business-related or activity-related acquaintances is often referred to as the individual's “network.” Note that, except where the context explicitly requires otherwise, the term “business” is used herein to refer generically to political, social, recreational, religious, and other activities and enterprises, as well as to traditional businesses.

Networking has always been an important need for many business persons. Office parties, trade conventions, civic organizations, charitable events, church activities, and many other business and social activities that are nominally held for other reasons often provide significant opportunities for networking. However, while these activities bring people together face-to-face, they typically present a host of distractions, including purely social interactions, organized meetings, and a general tendency for people to spend time with those whom they already know.

Sometimes, time is set aside for networking before and/or after an event held for some other purpose, such as a talk or panel discussion on a business or sports topic. However, these relatively brief periods of time tend to be socializing opportunities with little or no structure, and can be highly inefficient, with quality introductions resulting only occasionally and only by chance.

The internet and other means of electronic communication and commerce have given rise to new methods for networking. These include online special interest groups and topical “chat rooms,” as well as web services that are expressly dedicated to networking, such as LinkedIn. Such online networking can be more focused and time-efficient than in-person events, providing means for individuals to quickly seek out, from within a large group, those who are likely to be of strongest interest. However, at least initially, these online interactions are not face-to-face, and so there is an intrinsic difficulty in forming actual person-to-person relationships by electronic communication. In fact, such online services are often used by individuals primarily to keep track of their existing networks, rather than to form new relationships.

Another approach is to host an event that is explicitly dedicated to networking, with little or no other agenda. This type of event often includes a period during which each attendee is given a very short time (typically 60 to 90 seconds) in which to briefly introduce himself or herself to the group, and to state what goods and/or services his or her business provides. One problem with such networking events is that the emphasis is typically placed on what each attendee is seeking to “sell,” rather than how the attendees can help each other. The result can be a room full of consultants, individual proprietors, and sales people, all pitching their products and services, but with no one present who is likely to want to purchase anything that is being sold.

What is needed, therefore, is a method for efficiently and effectively bringing together individuals who can be of professional help to each other, and for facilitating introductions there between.

### SUMMARY OF THE INVENTION

A novel method for promoting and conducting professional networking events efficiently and effectively brings together individuals who can help each other professionally, and facilitates introductions there between. The fundamental elements of the invention can be expressed according to the acronym “COAR,” in that the invention includes opportunities for all attendees to “Communicate,” whereby each event attendee informs the group as to their identity and that of their organization; to “Offer,” whereby each individual offers something of value to the group; to “Ask,” whereby each attendee asks for something that they are specifically seeking; and to “Receive,” where attendees hopefully receive valuable help from each other.

In embodiments, the events are promoted ahead of time in at least one medium that has a regional focus and is directed to individuals who at least have access to strategic leaders in their fields. In various embodiments the attendees are required to register in advance, a fee is charged, and/or attendance is limited.

Each event begins with an informal social period during which attendees are set at ease and meet each other while cocktails are served. In embodiments, a list of attendees and their organizations is made available as the attendees enter, so that they can be aware of who is expected to attend and actively seek out other attendees of interest. In some embodiments, attendees are encouraged to inform the staff of any other attendees they would like to meet, and the staff makes appropriate introductions during the initial social period. In certain embodiments, attendees are photographed as they enter. According to the embodiment, the photos are posted as hard copies, displayed electronically, and/or distributed afterward to the attendees together with the attendee names and organizations.

In various embodiments, the attendees are given cards on which to record their “COAR” information. In embodiments, the cards are limited in size, so that any oral presentations given later will be brief. In some of these embodiments, the COAR information is then posted for all attendees to review. In certain embodiments, a receptacle is associated with each attendee's name and COAR information, so that other attendees who are interested in the “Offer,” the “Ask,” and/or otherwise interested in further interaction can deposit their business cards and be contacted later.

After the initial social period, a brief presentation is given by a guest speaker, which provides information likely to be of interest to a wide range of attendees. In embodiments, each attendee is then required to stand and make a brief presentation to the group, during which they present their COAR information. Specifically, each attendee states who they are and what organization they represent (“Communicate”). Each attendee is also required during their presentation to announce a special offer of some kind that he or she is offering to the group, for example a free sample, a free service, lunch at a specific restaurant, or some other inducement that is related to their business, or will otherwise encourage further discussion (“Offer”). Each attendee is further requires to indicate something that they are specifically seeking (“Ask”).

Attendees are provided with materials for taking notes, so that they can be efficient in seeking each other out. Before the event concludes, the attendees are given time to approach each other, typically to help each other in achieving their announced goals and/or to express interest in the special offers (“Receive”).

In other embodiments, in lieu of standing oral presentations, the attendees are given time to review written summaries of the “Communicate,” “Offer,” and “Ask” information, thereby allowing them to approach each other during an appropriate part of the meeting and/or contact each other later (“Receive”).

Written synopses of the attendee presentations are collected, and summaries of the attendee COAR information are distributed after the meeting to all attendees. In embodiments, the attendee offers must remain valid until and only until a subsequent meeting.

The present invention is a method for facilitating introductions between individuals who are likely to be of professional help to each other. The method includes hosting an event for a plurality of attendees; requiring each of the attendees at the event to communicate to the group information regarding his or her identity and the identity of the organization that he or she represents; requiring each attendee to inform the group regarding at least one special offer that the attendee is making that is not generally available, the offer being valid for a limited period of time after the event is concluded; requiring each attendee to ask the group for at least one result that he or she wishes to obtain; and providing time after the attendee asking for the attendees to approach each other for individual discussions, so that they can receive help from each other.

In embodiments, the steps of communicating, offering, and asking take place during an individual oral presentation made by the attendee to the group. In some of these embodiments the attendee presentations are limited to a maximum length of between 60 seconds and 90 seconds each.

In various embodiments, the steps of communicating, offering, and asking are accomplished by distributing written information regarding each attendee's information, offer, and request, and by allowing all attendees to review the written information.

In certain embodiments, a list of expected attendees is made available to the attendees to review as they arrive. In some of these embodiments, the method further comprises identifying by each attendee as they arrive of any other attendees whom they wish to meet, and performing of corresponding mutual introductions by staff who are supporting the event.

Some embodiments further include taking a photograph of each attendee, and making the photographs available to all attendees.

Other embodiments further include serving alcoholic beverages to the attendees at the event.

Various embodiments further include presenting by a guest speaker of information of wide interest to the attendees.

Certain embodiments further include promoting the event in a medium having a local focus. And in some of these embodiments, the medium provides information of interest to individuals who are able to affect business decisions at their organizations.

Some embodiments further include requiring each of the attendees to submit in writing a summary of the identity of his or her organization, the at least one special offer that he or she is making, and the at least one result that he or she wishes to obtain. Some of these embodiments further include posting the summaries for review by the attendees during the event. Other of these embodiments further include distributing the summaries to all attendees after the event.

Various embodiments further include requiring that the special offers remain valid only until a subsequent event is held.

In some embodiments, a fee is charged to individuals who wish to attend the event. In other embodiments, attendance at the event requires registration in advance. And in certain embodiments, the total number of attendees at the event is limited.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow diagram illustrating a first embodiment of the present invention; and

FIG. 2 is a flow diagram illustrating a second embodiment of the present invention.

### DETAILED DESCRIPTION

A novel method for promoting and conducting professional networking events efficiently and effectively facilitates beneficial introductions between individuals who have common interests and/or who can be of help to each other. The fundamental elements of the invention can be expressed according to the acronym “COAR,” in that the invention includes opportunities for each attendee to “Communicate,” whereby each event attendee informs the group as to their identity and that of their organization; to “Offer,” whereby each individual offers something of value to the group; to “Ask,” whereby each attendee asks for something that they are specifically seeking; and to “Receive,” where attendees hopefully receive valuable help from each other.

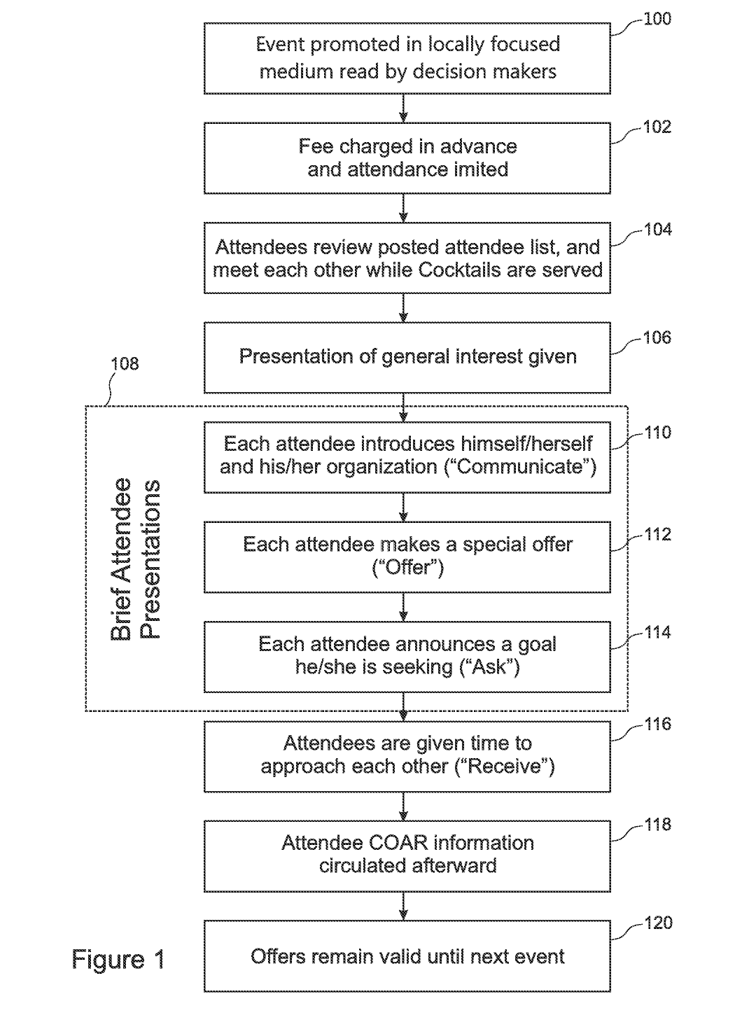

With reference to FIG. 1, in embodiments each event is promoted ahead of time in at least one medium that has a regional focus and is directed to individuals who at least have access to strategic leaders in their fields 100. In various embodiments, attendees are required to register in advance, a fee is charged, and/or attendance is limited 102.

As the attendees arrive at the meeting, they are able to review a posted list of expected attendees and their organization 104. In some embodiments, the staff asks if there is anyone they would like to meet, and performs appropriate introductions during an initial social period during which cocktails are served 104. In embodiments, each attendee is given a card on which to record a summary of their “COAR” information. In some embodiments, the cards are small, thereby forcing the attendees to be brief and concise, both in writing and later during oral presentations.

A presentation follows from a guest speaker 106, providing information likely to be of interest to a wide range of attendees. In the embodiment of FIG. 1, each attendee is then required to stand and make a brief presentation to the group 108, during which they briefly state who they are 110 (“Communicate”). Each attendee is also required during his or her presentation to make a special offer of some kind to the group 112 (“Offer”), typically a free sample, a free service, a meal at a specific restaurant, or some other inducement that is related to their business or will otherwise encourage further discussion. Attendees are further required to describe something that they are seeking 114 (“Ask”).

Before the event concludes, the attendees are given time to approach each other 116, typically to help each other in achieving their stated goals and/or to express interest in the special offers (“Receive”).

These elements work together in a highly synergistic way. Promoting the event in a trade medium with a regional focus 100 increases the likelihood that the attendees will represent businesses that either have their headquarters in the local area, or at least an important branch office in the area. Selecting a trade medium that is directed to strategic business leaders and to those who have access thereto helps to ensure that most attendees will be able to make or influence decisions at their organizations, thereby increasing the likelihood that the attendees can be of professional help to each other.

Requiring advance registration, charging a fee to attend, and limiting attendance 102 induces each attendee to make a personal commitment and an investment in advance of the meeting. As a result, attendees tend to give the event a high priority and rarely fail to attend. And when they arrive at the event, they are determined to take it seriously and to “make it work” for them.

Posting a list of expected attendees with their “COAR” information 104 and providing materials for taking notes helps the attendees to efficiently identify and seek out others who might be helpful to them, or whom they may be able to help. Introductions performed by the staff further helps to create a comfortable and relaxed atmosphere.

Serving cocktails at the beginning 104 serves as an added inducement to attend, and also tends to create a relaxed and congenial atmosphere in which attendees will be more likely to look for ways to help each other and to think “outside of the box.” It also helps to prepare the attendees to stand up and address the group, which might otherwise be uncomfortable or stressful for some.

The presentation by a featured speaker 106 provides further inducement for attendees. Even if an attendee does not form any useful connections at a given event, he or she will at least have obtained some valuable information.

The attendee presentations 108 are at the heart of the invention. After stating who they are and who they represent 110 (“Communicate”), each attendee is required to announce an offer or inducement of some kind 112 (“Offer”). For example, a free consultation, tickets to an event, a free lunch at a specific restaurant, and such like. Knowing ahead of time that each attendee will make a special offer serves as a strong added inducement to attend the event, since it is human nature to want to take advantage of a special offer or “deal,” and so individuals often look forward with excitement and anticipation to hearing about such offers. In addition, the offers can be of significant value to the attendees making them, since once an individual has taken advantage of a special offer and has appreciated its benefits, the individual is likely to try to repay the favor in some way. At the very least, an individual is likely to take time over a free lunch to get to know the host better and learn about what they do and what they offer, and the individual may try even harder afterward to help the host who provided the lunch.

Each attendee is then required to state what they are looking for 114 (“Ask”). In some embodiments the attendees are allowed to make general statements, such as “new customers for . . . ” followed by a re-statement of whatever their business provides. However, attendees are strongly encouraged to be highly specific. For example, “I would like to be introduced to someone who makes strategic decisions in the IT department of XYZ Corporation.” Such rather specific requests are often highly effective at stimulating the creative problem solving abilities of the other attendees, whereas a general appeal for new customers typically stimulates fewer responses.

Attendees are strongly encouraged to take notes during the individual presentations 108, so that they can efficiently approach each other during the final period of the event 116, and so that they can remember details later if an opportunity should arise to help a fellow attendee (“Receive”). In embodiments, writing materials are provided to the attendees specifically for taking notes.

Attendees are also required to document the highlights of their presentation in writing on provided forms, including their goals and special offers, and these forms are collected afterward so that the information can be summarized and distributed later to everyone who attended 118. In embodiments, it is a rule that all of the special offers must remain valid until and only until the next event is held 120. Of course, this encourages attendees not to delay in taking each other up on their offers. Also, it helps to promote the next event.

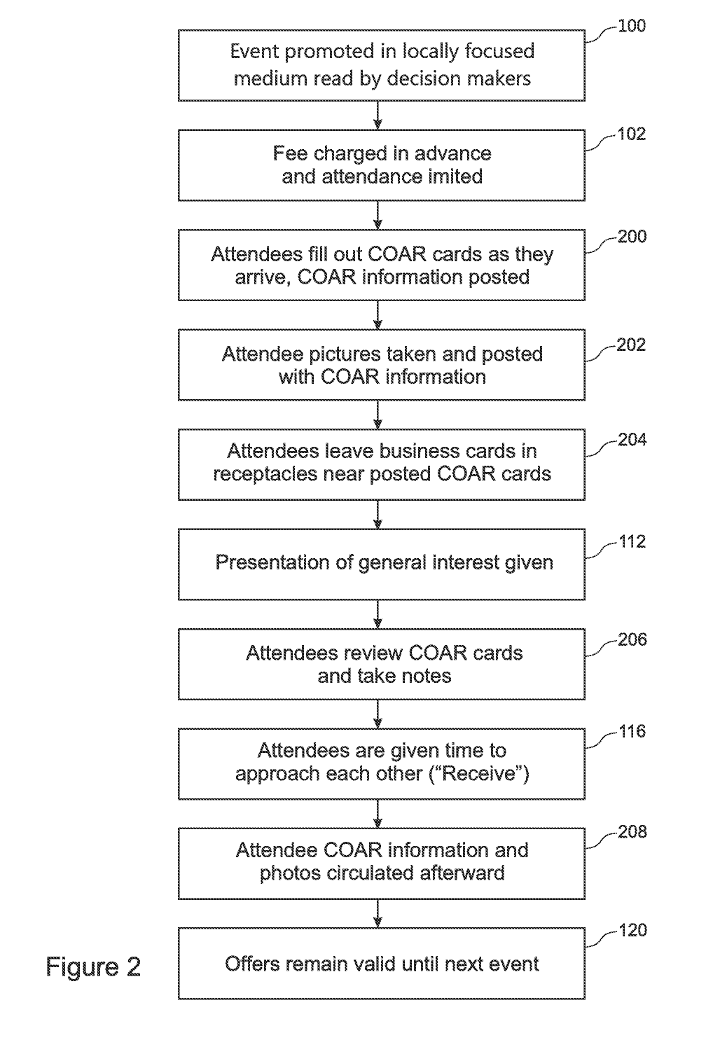

With reference to FIG. 2, in some embodiments attendees enter their COAR information onto COAR cards as they arrive, and these COAR cards are posted for all attendees to review. In some embodiments, photographs 202 are taken of the attendees as they arrive, or beforehand if they are members of the sponsoring organization. These photos are then displayed and or posted for review during the meeting and in some embodiments receptacles are provided for attendees to leave notes and/or business cards 204 if they wish to pursue further contact.

In the embodiment of FIG. 2, attendees do not give oral presentations 108. Instead, they are given the opportunity to review each other's posted COAR information 206, and then to seek each other out, either during the meeting 116 or afterward 208. The approach of FIG. 2 may be preferred for example if it is desirable to host a large group of attendees, such that individual oral presentations would be too time consuming.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for facilitating introductions between individuals who are likely to be of professional help to each other, the method comprising:
hosting an event for a plurality of attendees;
requiring each of the attendees at the event to communicate to the group information regarding his or her identity and the identity of the organization that he or she represents;
requiring each attendee to inform the group regarding at least one special offer that the attendee is making that is not generally available, the offer being valid for a limited period of time after the event is concluded;
requiring each attendee to ask the group for at least one result that he or she wishes to obtain; and
providing time after the attendee asking for the attendees to approach each other for individual discussions, so that they can receive help from each other.

2. The method of claim 1, wherein the steps of communicating, offering, and asking take place during an individual oral presentation made by the attendee to the group.

3. The method of claim 2, wherein the attendee presentations are limited to a maximum length of between 60 seconds and 90 seconds each.

4. The method of claim 1, wherein the steps of communicating, offering, and asking are accomplished by distributing written information regarding each attendee's information, offer, and request, and by allowing all attendees to review the written information.

5. The method of claim 1, wherein a list of expected attendees is made available to the attendees to review as they arrive.

6. The method of claim 5, wherein the method further comprises identifying by each attendee as they arrive of any other attendees whom they wish to meet, and performing of corresponding mutual introductions by staff who are supporting the event.

7. The method of claim 1, further comprising taking a photograph of each attendee, and making the photographs available to all attendees.

8. The method of claim 1 further comprising serving alcoholic beverages to the attendees at the event.

9. The method of claim 1, further comprising presenting by a guest speaker of information of wide interest to the attendees.

10. The method of claim 1, further comprising promoting the event in a medium having a local focus.

11. The method of claim 10, wherein the medium provides information of interest to individuals who are able to affect business decisions at their organizations.

12. The method of claim 1, further comprising requiring each of the attendees to submit in writing a summary of the identity of his or her organization, the at least one special offer that he or she is making, and the at least one result that he or she wishes to obtain.

13. The method of claim 12, further comprising posting the summaries for review by the attendees during the event.

14. The method of claim 12, further comprising distributing the summaries to all attendees after the event.

15. The method of claim 1, further comprising requiring that the special offers remain valid only until a subsequent event is held.

16. The method of claim 1, wherein a fee is charged to individuals who wish to attend the event.

17. The method of claim 1, wherein attendance at the event requires registration in advance.

18. The method of claim 1, wherein a total number of attendees at the event is limited.
